(19) United States
(12) Patent Application Publication
(10) Pub. No.: US 2012/0023123 A1
(43) Pub. Date: Jan. 26, 2012

(54) Zapaat Context Web Search

(76) Inventor: Syamantak Saha, New York, NY (US)

(21) Appl. No.: 12/832,591

(22) Filed: Jul. 21, 2010

(51) Int. Cl. G06F 17/30

(52) U.S. Cl. 707/769; 707/E17.014

(57) ABSTRACT

Current Internet search methods use Keywords as input to provide information back to users. However, this method provides information which might not be the web pages which are being searched. Due to the conceptual singular input of Keyword, the efficiency of the information provided is compromised.

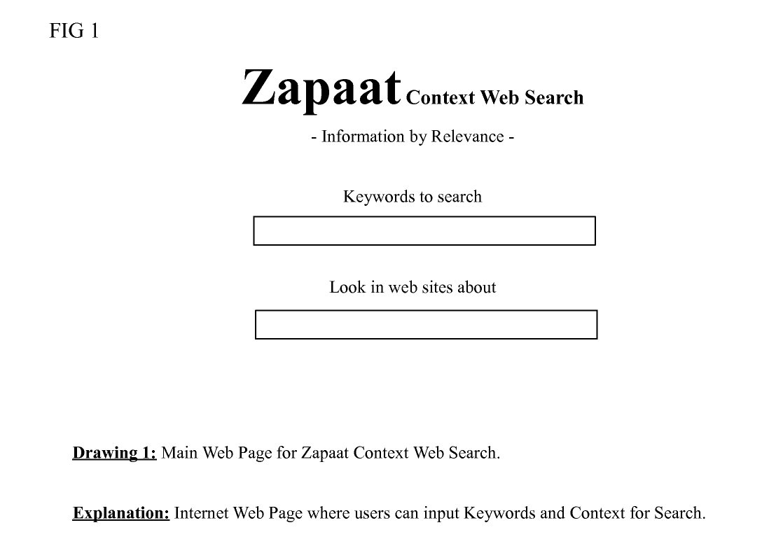

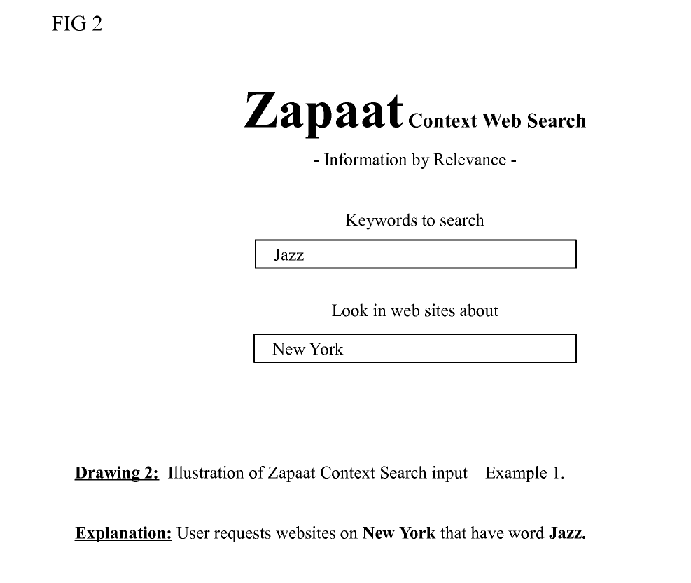

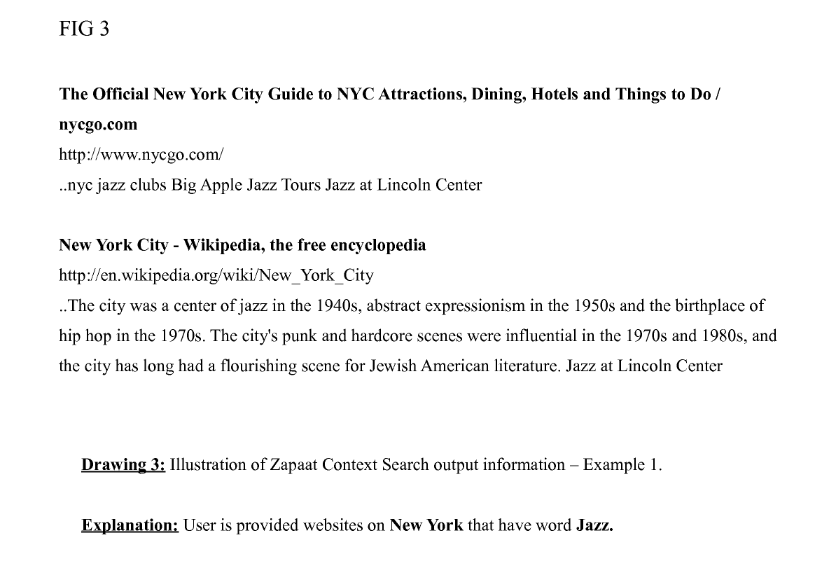

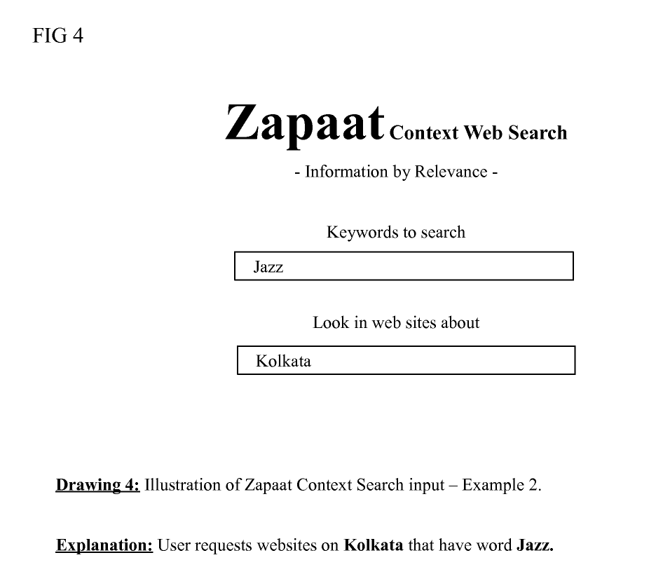

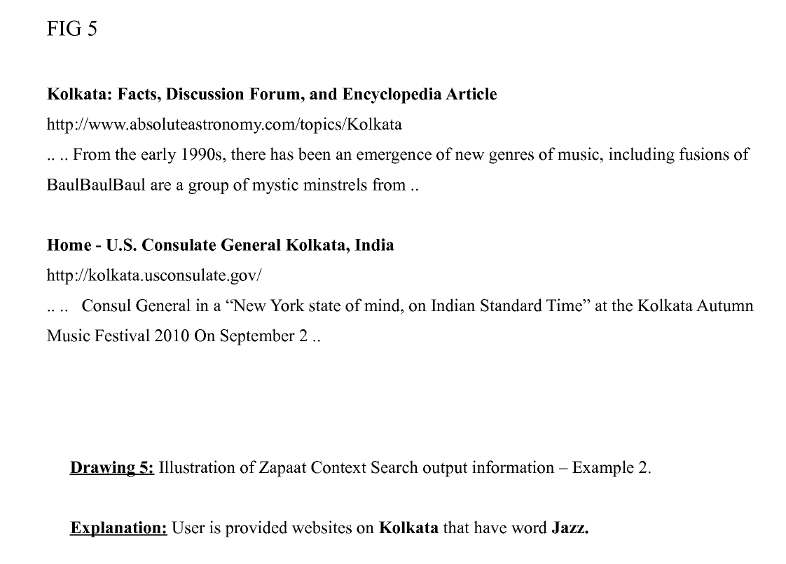

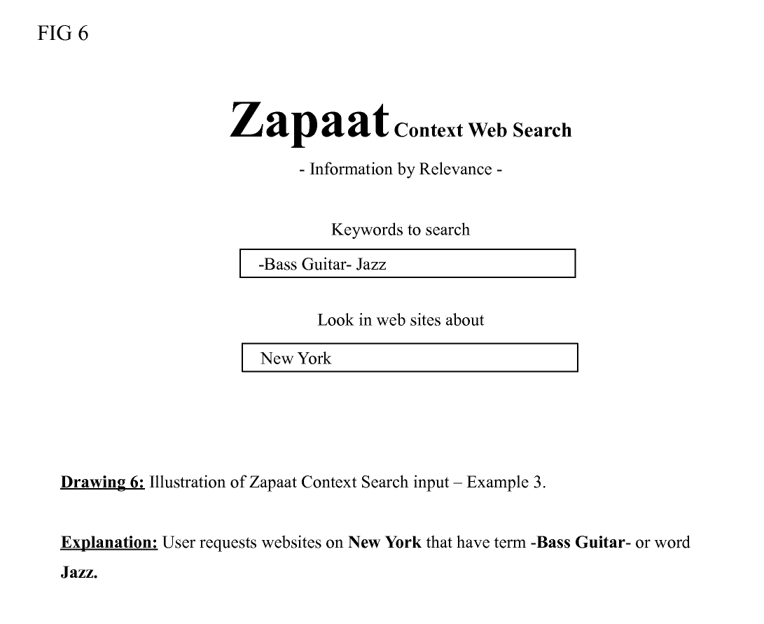

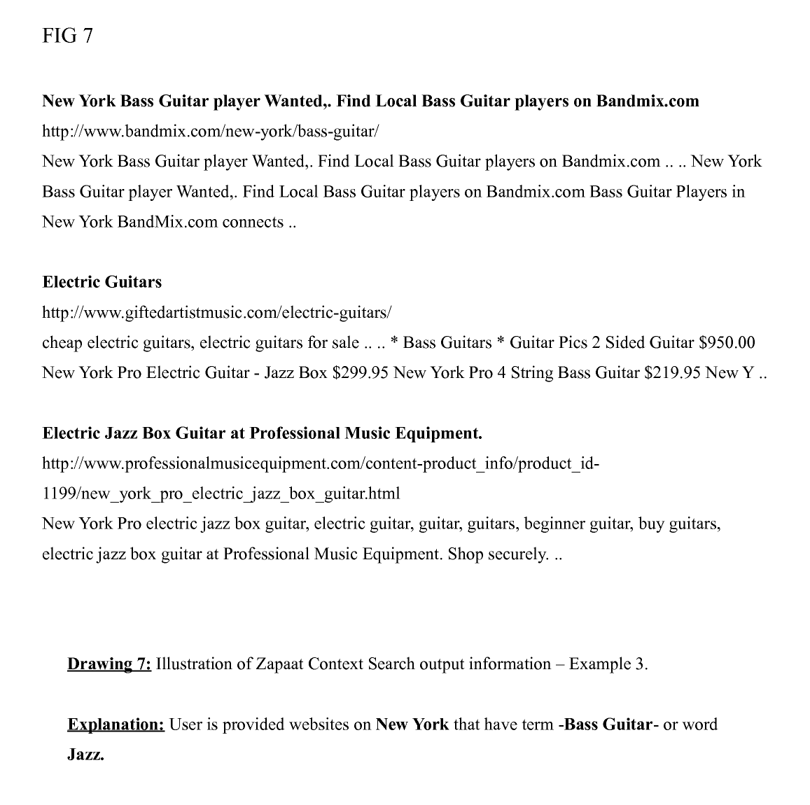

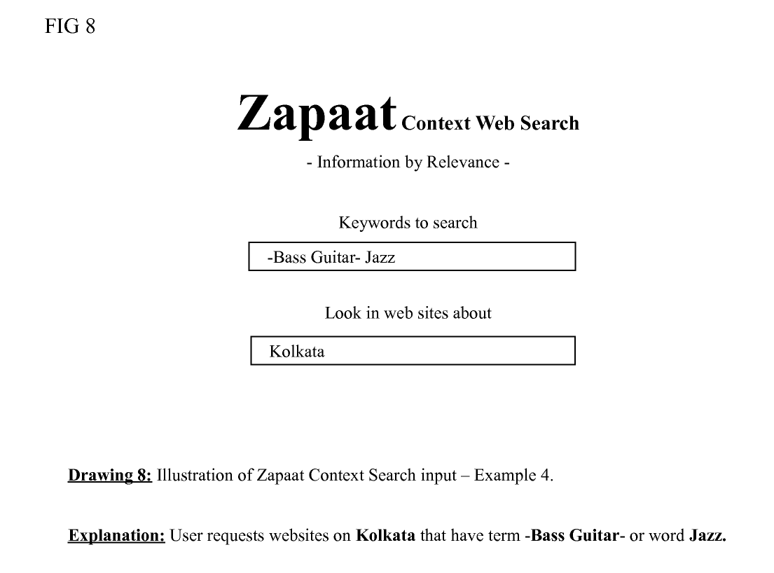

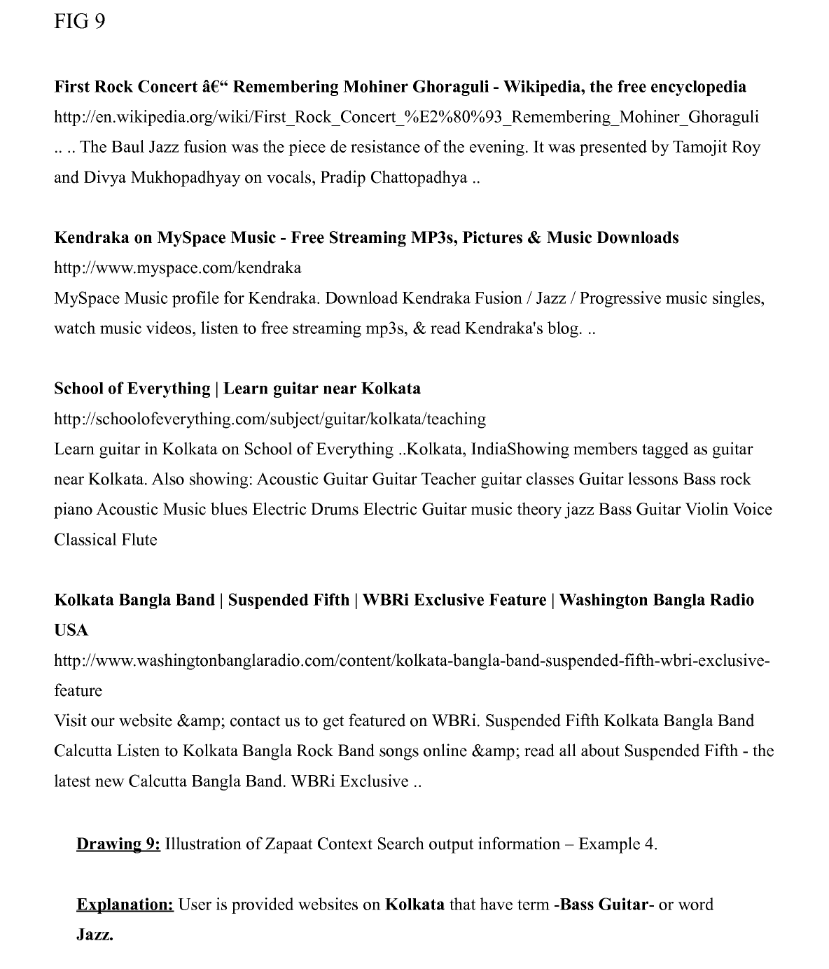

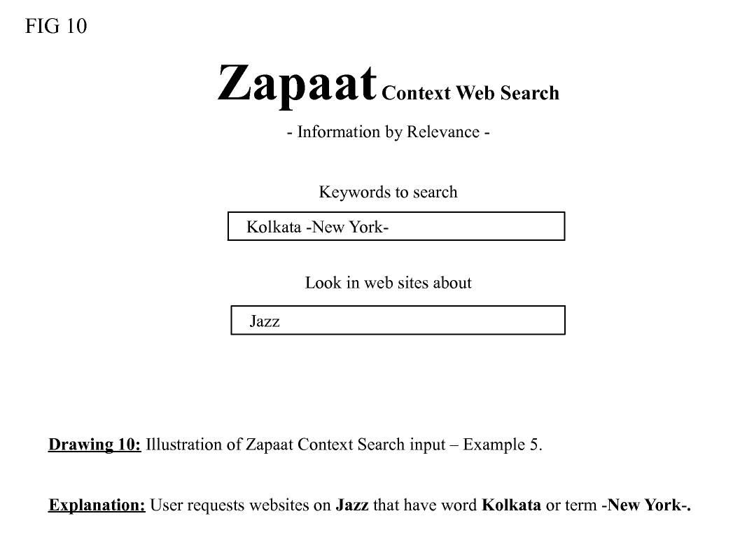

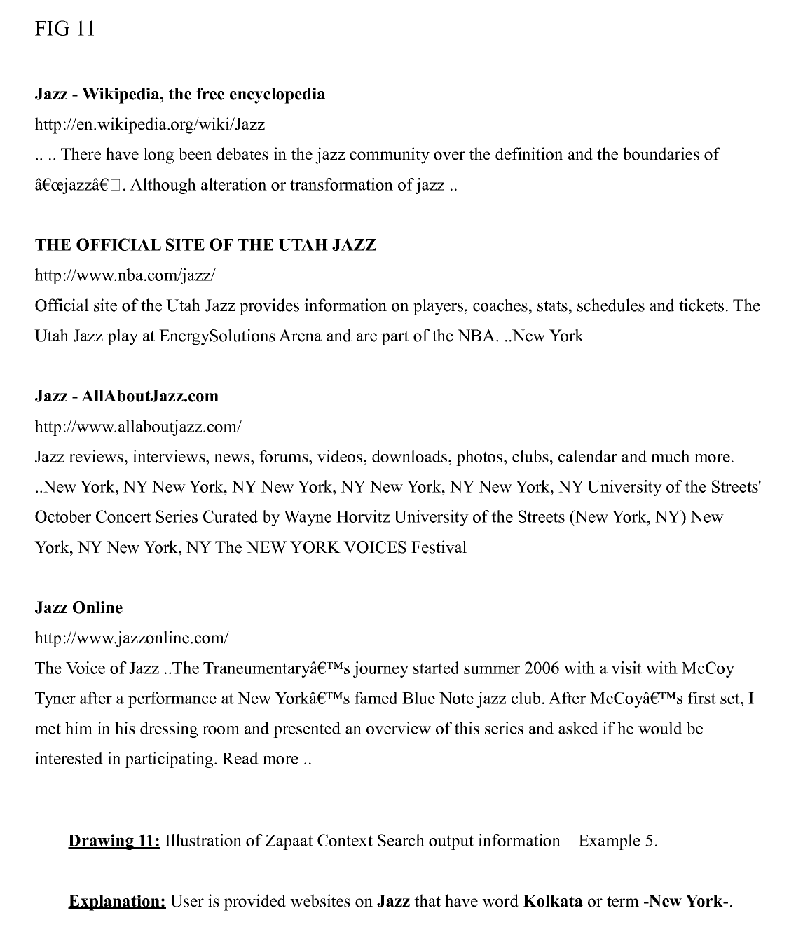

Zapaat introduces a conceptualised dual input search method where the user enters Keywords as well as Context for the web search, where Context is the description of the kind of websites. The added dimension of Context enables the Internet user to define what kind of websites to search the keywords. Using this technique, a more accurate search information is provided to the internet user.

### CROSS-REFERENCE TO RELATED APPLICATIONS Ser. No. 12/832,591

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF INVENTION

1. Field of the Invention
Internet Searching
Software Engineering

2. Description of Related Art

With the ever-increasing size of the internet, there is a pressing need to easily find the information that we are searching.

Current Internet search methods are done by using only keywords.
Usually one text box where you can enter the keywords which you are searching.
Information returned brings up all web pages which have those words.
Usually includes web pages which are not about your search.
Scan through the returned information list to find the web pages being searched.
Very time consuming. Takes a lot of page browsing to find the actual result.
Often the information being searched is not found.

### BRIEF SUMMARY OF THE INVENTION

Zapaat Context Web Search addresses the existing issues of Internet Searching by providing a more effective method for conducting searches.
Allows you to search for the keywords using a context for the search.
Has an added dimension of context which brings relevance to the search.
The context for the search allows users to define what kind of websites the keywords should be searched.
Information provided is more relevant to the search.
Less information to scan through to find the relevant web pages.
Saves time per web page find.

Current Search Methods

Searching for keyword ‘Obama’ in ‘news’ type webpages.
Search text is ‘Obama news’.
   Information provided are like:
      www.barackobama.com
      theobamanews.com
      www.topix.com

Zapaat Context Web Search

Search for Keyword ‘Obama’ in ‘news’ type websites.
Search Keyword is ‘Obama’
Search Context (kind of websites or websites about) is ‘news’
   Information provided are like:
   http://www.aolnews.com/
      http://www.nytimes.com/
      http://www.cnn.com/

As observed from the above, a more relevant information is retrieved from the Internet using Zapaat Context Web Search.

### BRIEF DESCRIPTION OF THE SEVERAL VIEWS OF THE DRAWING(S)

Drawing 1: Main Web Page for Zapaat Context Web Search

Explanation: Internet Web Page where users can input Keywords and Context for Search.

Drawing 2: Illustration of Zapaat Context Search input—Example 1.

Explanation: User requests websites on New York that have word Jazz.

Drawing 3: Illustration of Zapaat Context Search output information—Example 1.

Explanation: User is provided websites on New York that have word Jazz.

Drawing 4: Illustration of Zapaat Context Search input—Example 2.

Explanation: User requests websites on Kolkata that have word Jazz.

Drawing 5: Illustration of Zapaat Context Search output information—Example 2.

Explanation: User is provided websites on Kolkata that have word Jazz.

Drawing 6: Illustration of Zapaat Context Search input—Example 3.

Explanation: User requests websites on New York that have term -Bass Guitar- or word Jazz.

Drawing 7: Illustration of Zapaat Context Search output information—Example 3.

Explanation: User is provided websites on New York that have term -Bass Guitar- or word Jazz.

Drawing 8: Illustration of Zapaat Context Search input—Example 4.

Explanation: User requests websites on Kolkata that have term -Bass Guitar- or word Jazz.

Drawing 9: Illustration of Zapaat Context Search output information—Example 4.

Explanation: User is provided websites on Kolkata that have term -Bass Guitar- or word Jazz.

Drawing 10: Illustration of Zapaat Context Search input—Example 5.

Explanation: User requests websites on Jazz that have word Kolkata or term -New York-.

Drawing 11: Illustration of Zapaat Context Search output information—Example 5.

Explanation: User is provided websites on Jazz that have word Kolkata or term -New York-.

### DETAILED DESCRIPTION OF THE INVENTION

Zapaat introduces a new method to search the internet, significantly reducing the time taken per find.

Zapaat introduces the concept of Context for web searches.

Context for the web search means, that the user can define in what kind of websites, the keywords should be searched.

To construct an internet search, Zapaat uses the following user inputs:
Keyword(s) to search
______
Look in web sites about
______

If an Internet User wants to search websites on New York for the word Jazz:
Keyword(s) to search
_Jazz_{—}
Look in web sites about
_New York_{—}

Context for Zapaat cSearch

The input ‘Look in web sites about’ brings a Context to the Internet Search.

To illustrate how ‘ Look in web sites about’ makes a difference to the search, let us consider the example below:

Suppose an User wants to find websites on New York that has the word Jazz. This can be done with the following inputs for Zapaat:
Keyword(s) to search
_Jazz_{—}
Look in websites about
_New York_{—}

Next, the User wants to find websites on Kolkata that has the word Jazz. This can be done with the following inputs for Zapaat:
Keyword(s) to search
_Jazz_{—}
Look in websites about
_Kolkata_{—}

The search for Jazz in websites about New York, would provide different information to the search for Jazz in websites about Kolkata.

This is because Kolkata or New York brings context to the search for Jazz.

This means, it tells Zapaat, in what kind of websites (e.g Kolkata, New York) to search for Jazz.

Using hyphens for -connected words-

Zapaat allows you to use hyphens to highlight connected words.

For example:

If I want to search webpages that has word guitar then
Keyword(s) to search
_guitar_{—}

If I want to search webpages that have word guitar or word drums then
Keyword(s) to search
_guitar drums_{—}

If I want to search webpages that have the term bass-guitar then
Keyword(s) to search
   _-bass-guitar-_{—}

If I want to search webpages that have the term -bass guitar- or the word drums then
Keyword(s) to search
   _-bass guitar- drums_{—}

1. No other Internet Search provides a conceptualised dual input search with Keyword and Context Definition, where Context is the description of the kind of websites.
No other Internet Search provides Connected Word concept in conjunction with Keyword and Context Definitions, where Context is the description of the kind of websites.
